(19) United States
(12) Patent Application Publication
(10) Pub. No.: US 2015/0134960 A1
(43) Pub. Date: May 14, 2015

(54) DETERMINATION OF CRYPTOGRAPHIC KEYS

(71) Applicant: KONINKLIJKE PHILIPS N.V., EINDHOVEN (NL)

(72) Inventors: Oscar Garcia Morchon, Aachen (DE); Ludovicus Marinus Gerardus Maria Tolhuizen, Waalre (NL)

(21) Appl. No.: 14/400,572

(22) PCT Filed: Apr. 24, 2013
(86) PCT No.: PCT/IB2013/053224

§ 371 Date: Nov. 12, 2014

Related U.S. Application Data
(60) Provisional application No. 61/732,997, filed on Dec. 4, 2012.
(60) Provisional application No. 61/649,464, filed on May 21, 2012.

(30) Foreign Application Priority Data
Jul. 12, 2012 (EP) 12196092.6

(51) Int. Cl. H04L 9/16; H04L 9/08

(52) U.S. Cl. CPC H04L 9/16; H04L 9/0819; H04L 2209/24
USPC 713/171

(57) ABSTRACT

A first communication unit (101) comprises: a processor (203) for obtaining local key material defining a first key generating function from a Trusted Third Party (TTP). An identity processor (205) obtaining an identity for a second communication unit (103 and a key generator (207) determines a first cryptographic key from the first key generating function based on the identity. A generator (209) locally generates a perturbation value which is not uniquely determined by data originating from the TTP. A key modifier (211) determines a shared cryptographic key by applying the perturbation value to the first cryptographic key. The second communication unit (103) also obtains key modifying data and uses it to determine a cryptographic key for the first communication unit (101). It then generates possible values of the perturbation value, and subsequently possible shared cryptographic keys. It then selects one that matches cryptographic data from the first communication unit (101). The perturbation value may provide increased resistance against collusion attacks.

### FIELD OF THE INVENTION

The invention relates to determination of cryptographic keys, and in particular to shared keys based on local key material from a trusted authority.

### BACKGROUND OF THE INVENTION

Communication systems have become ubiquitous and include both wired and wireless systems as well as private and public networks. For example, one widespread set of wireless communication standards is the Wi-Fi family of communication standards which is for example used in many homes to provide wireless networking and Internet access. The Wi-Fi family of communication standards includes amongst others the widespread IEEE 802.11a, IEEE 802.11b, IEEE 802.11g, and IEEE 802.11n standards defined by the Institute of Electrical and Electronic Engineers (IEEE). Wi-Fi is also widely used in shops, hotels, restaurants etc. to provide wireless Internet access.

An important aspect for many communication systems and applications is that secure and private/secret communications can be supported. Security considerations include requirements to make the communication decodable only by the intended parties, i.e. it requires the communication approach to support confidential communications that cannot be intercepted and decoded by other parties. It also includes requirements to ensure that the information has been received from the correct source, i.e. that the received data is properly authenticated. Security considerations also include a desire to ensure that the communication is between the intended parties and not e.g. a third party pretending to be the intended party. Such security should preferably ensure that third parties cannot eavesdrop on the over the air communications, i.e. that a third party cannot receive the radio transmissions and successfully retrieve decode the data.

In order to provide secure communication, data transmissions may be encrypted. However, in order to encrypt data, the two devices must be able to securely setup an encryption key to be used. It is important that this encryption key is only known by the intended parties.

Many secure communication systems employ a trusted authority, also referred to as the network authority or as the Trusted Third Party (TTP), that provides encryption information which can then be used in the individual devices to determine suitable keys. The trusted authority is assumed to be secure and provide cryptographic data that is reliable, and for which the distribution is tightly controlled. This is typically ensured by implementing an administrative system ensuring the trusted authority is operated by reputable organizations that are trusted with the integrity and security of the system.

In many systems, the trusted authority does not provide individual cryptographic keys to be used by the devices but rather provide key material that allows the individual devices to establish an approach for generating a cryptographic key. For example, the trusted authority may transmit data to a first device which specifies how this device should calculate the cryptographic key. The data may for example define a cryptographic function which defines how a cryptographic key should be generated as a function of a device identity of another device with which the first device wants to establish a secure communication.

The trusted authority will transmit data to a plurality of devices such that each device can locally generate a cryptographic key based on this data and a given device identity. Furthermore, the functions are selected such that they are symmetric, i.e. the function of device A will calculate a cryptographic key based on the identity of device B which is identical to the cryptographic key that will be calculated by device B using device A. Thus, if the function for generating the cryptographic key in device A is denoted K_{A} and the function for generating the cryptographic key in device B is denoted K_{B}, then K_{A} (B)=K_{B}(A).

In this way the two devices will independently calculate the same cryptographic key based on the information received from the trusted authority.

The functions are distributed securely such that the individual function is only known by the individual device to which the key material is provided from the trusted authority. Furthermore, the functions are derived such that it is not possible to derive the function from the resulting key, e.g. it is not possible to determine the function K_{A} from the knowledge of the key K_{A}(B) or equivalently from the knowledge of the (same) key K_{B}(A). Thus, devices are not able to calculate the functions used by the individual devices from public information. Accordingly, a third device C cannot determine any of the functions K_{A} or K_{B} and accordingly cannot determine the shared cryptographic key K_{A} (B)=K_{B}(A) even if the identities A and B are known.

However, an issue with this approach is that it cannot be guaranteed that a third party cannot determine the underlying key generating functions if enough samples of encryption keys are known for a given device under attack. For example, if a so called collusion attack is attempted wherein an attacking party combines functions from a number of devices to generate cryptographic keys for one other device, it may be possible to determine the underlying function used by that device. For example, if information is available on shared keys calculated for a number of devices, e.g. K_{C}(A), K_{D}(A), K_{E}(A), K_{F}(A) etc, it may be possible to determine K_{A} provided the number of keys known is high enough.

As a specific example, a possible attack aiming to obtain information on the function K_{A} used by device A will be described. In the example, the attacker uses multiple compromised devices with identifiers B₁, B₂, . . . , Bₘ. The attacker knows the respective secret key generating functions of these devices. Whenever, a communication is initialized between device A and device Bᵢ , the attacker can retrieve K_{A}(Bᵢ), as explained above (i.e. by determining K_{Bi}(A). In the example, the function K_{A} is a polynomial, which means that K_{A} can be retrieved with a relatively low value of m, namely, viz. with m being one larger than the degree of the polynomial K_{A}. In order to thwart this attack, m may be selected to be very large. However, this would lead to substantially increased complexity of the evaluation of K_{A}, which can be problematic for devices with limited memory or when speed of computation is relevant. As a specific example, if K_{A} is of the form K_{A}(x)=<<f_{A}(x)>_{N}>₂^{b}, where f_{A} is a polynomial of known degree and <a>_{N} is the remainder after dividing a by N, then it is also feasible to retrieve f_{A} depending on the relative values of the degree a of f_{A} and b. In particular, if a<√b, then it is possible to recover f_{A} by means of lattice reduction techniques, thereby resulting in K_{A} being determined and the system being compromised.

This is explained in detail by the inventors in O. Garcia-Morchon, L. Tolhuizen, D. Gomez and J. Gutierrez, “Towards fully collusion-resistant ID-based establishment of pairwise keys”, Report 2012/618 at the Cryptology Preprint Archive, available as http://eprint.iacr.org/2012/618.pdf.

Accordingly, greater resilience against attacks in which several devices collude (or are used by an attacker) in order to find information on keys generated by other pairs of devices would be desirable.

Hence, an improved approach would be advantageous and in particular an approach allowing increased flexibility, reduced complexity, increased security, compatibility with many implemented security approaches and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided a method of operation for a first communication unit, the method comprising, obtaining local key material for the first communication unit, the local key material originating from a Trusted Third Party and defining a first key generating function for generating a cryptographic key as a function of at least one identity; obtaining an identity for a second communication unit, the second communication unit being different from the first communication unit; determining a first cryptographic key from the first key generating function based on the identity; locally generating a perturbation value for the first cryptographic key, the perturbation value not being uniquely determined by data originating from the Trusted Third Party; and determining a second cryptographic key by applying the perturbation value to the first cryptographic key.

The invention may allow improved security for a communication between two or more communication units. In particular, reduced sensitivity to collusion attacks can be achieved. The perturbation value may introduce (possibly additional) uncertainty in the relationship between the shared cryptographic key and keys corresponding to fully symmetric key generating functions. This uncertainty increases the uncertainty for any colluding third parties seeking to determine the first key generating function from shared keys derived from the first key generating function. As such derivation includes considering multiple derived keys for different identities, the variations of possible perturbation values increase the uncertainty substantially, typically rendering it practically infeasible to perform a collusion attack to determine the first key generating function.

The second cryptographic key may be used as a shared cryptographic key, e.g. for secure communication between the first communication unit and second communication unit and/or for cryptographic authentication of data, e.g. using a cryptographic hash.

The first key generating function belongs to a set of key generating functions for communication units, at least some pair of the key generating functions being non-symmetric. The non-symmetry between a pair of key generating functions may have predetermined characteristics, such as a maximum difference or a limited number of possible differences between cryptographic keys generated from a pair of non-symmetric key generating functions. Such characteristics may facilitate the determination of a shared key based on cryptographic keys generated from a pair of asymmetric key generating functions. Specifically, the first key generating function may be a function from a set of pairwise substantially symmetric functions, with e.g. the non-symmetry being restricted to result in corresponding cryptographic keys differing by less than a threshold, the threshold being e.g. 1%, 2%, 5% or 10% of the magnitude of the key.

Specifically, the first generating function may belong to a set of non-symmetric key generating functions corresponding to a set of symmetric key generating functions offset by different obfuscating values. The maximum magnitude of the obfuscating values may e.g. be limited to 1%, 2%, 5% or 10% of the maximum magnitude for the key. Specifically, the Trusted Third Party may generate a set of key generating functions by first determining a set of symmetric key generating functions, and then adding an obfuscating (possibly random) value to each key generating function. The addition may for example be a modular addition.

Introducing a perturbation value to the individual keys generated from the first key generating function introduces additional uncertainty. In particular, it introduces additional non-symmetry between the keys generated in two communications units using key generating functions from the set of key generating functions. Furthermore, a communication unit cannot determine whether or to which extent the/difference in the generated cryptographic keys is due to the non-symmetry of the underlying key generating functions defined by the Trusted Third Party or to the non-symmetry introduced by the perturbation values. The non-symmetry of the key generating functions may be constant, but the perturbation value may vary e.g. between communication units (for different identities) and/or for each key establishment operation. As communication units cannot differentiate between these, the relationship between the key generating functions is obfuscated.

For example, if the key generating functions are generated by adding different obfuscating values to fully symmetric key generating functions, the resulting key may correspond to the underlying symmetric function being offset by a value which is the sum of the obfuscating value introduced by the Trusted Third Party and the perturbation value introduced by the communication unit. The obfuscating value may often be constant for a given communication unit/key generating function. The perturbation value is locally generated by the communication unit and is at least partially unknown to other communication units (and the Trusted Third Party). Another communication unit may at best be able to determine the difference between the received key and the key generated from its local key generating function. The combined difference corresponds to sum of the obfuscating values for the two key generating functions and the perturbation value. However, the communication unit cannot separate the combined difference into the individual parts and therefore cannot remove the effect of the perturbation value. Accordingly, when trying to determine the first key generating function from the knowledge of the established cryptographic keys, attacking colluding communication units cannot for each communication unit determine the value generated by the first key generating function, rather it can only generate a number of possible values corresponding to the uncertainty of the perturbation value. Thus, rather than each key setup providing one sample of the result of a key generating function that the attacking communication units are seeking to determine, it at best provides a set of multiple possible keys that were generated by the key generating function. As results for multiple communication units must be analyzed to determine the first key generating function, the required complexity increases with the product of the number of possible keys for each communication unit, i.e. with the number of combinations of possible perturbation values that may have been used in each key setup. This complexity increase renders collusion attacks impractical in practice.

The local key material may uniquely define the first key generating function. The perturbation value is not uniquely dependent on information received from the Trusted Third Party. Thus, the shared key is not uniquely defined by the Trusted Third Party. Accordingly, other communication units cannot assume that the generated key is uniquely given from a static key generating function. Attacking colluding communication units accordingly need to consider all possible values of the perturbation value when combining results from different communication units.

The perturbation value may vary between at least some shared key setups, such as e.g. different key setups for communication between the same communication units, or between different communication units.

The process for generating the perturbation value may be confidential/secret to the first communication unit. The perturbation value may be generated at least partly based on data which is not available externally to the first communication unit. In many embodiments, the perturbation value may include a random element. The perturbation value may be determined independently of the local key material.

The Trusted Third Party may be a central cryptography server or a network authority. The first key generating function may be a univariate function of the identity. The perturbation value will be non-zero for at least some key establishments.

The Trusted Third Party may be arranged to perform a method of configuring the first communication unit for key sharing, the method comprising: obtaining in electronic form a private modulus (p₁), a public modulus (N), and a bivariate polynomial (f₁) having integer coefficients, the binary representation of the public modulus and the binary representation of the private modulus are the same in at least key length (b) consecutive bits, generating local key material for the first communication unit comprising: obtaining in electronic form an identity number (A) for the network device, determining using a polynomial manipulation device a univariate polynomial from the bivariate polynomial by substituting the identity number into the bivariate polynomial, reducing modulo the private modulus the result of the substitution, and electronically storing the generated local key material at the first communication unit.

Generating local key material for the first communication unit may comprise generating an obfuscating number and adding, using a polynomial manipulation device, the obfuscating number to at least one coefficient of the univariate polynomial to obtain an obfuscated univariate polynomial, the generated local key material comprising the obfuscated univariate polynomial. The bivariate polynomial (f₁) may be a symmetric polynomial.

In some embodiments, the generating local key material for the network device comprises generating an obfuscating number, e.g., by using an electronic random number generator, and adding using a polynomial manipulation device, the obfuscating number to a coefficient of the univariate polynomial to obtain an obfuscated univariate polynomial, the generated local key material comprising the obfuscated univariate polynomial. More than one coefficient may be obfuscated, preferably with different coefficients being obfuscated differently. In an embodiment, the generating local key material for the network device comprises generating multiple obfuscating numbers, e.g., by using the electronic random number generator, and adding using the polynomial manipulation device, each obfuscating number of the multiple obfuscating numbers to a respective one of the coefficients of the univariate polynomial to obtain an obfuscated univariate polynomial. In some embodiments, an obfuscated number is added to each coefficient of the univariate polynomial.

The obfuscating number and/or the perturbation value may be restricted to positive numbers but this is not necessary and values may also be negative. In an embodiment, the obfuscated numbers are generated using a random number generator. Multiple obfuscating numbers may be generated and added to coefficients of the univariate polynomial to obtain the obfuscated univariate polynomial. One or more, preferably even all, coefficients of the univariate polynomial may be obfuscated in this manner.

The local key material may define an, optionally obfuscated, univariate polynomial and the operation of the first key generating function may include substituting the identity of a second communication device into the, optionally obfuscated, univariate polynomial, reducing the result of the substituting modulo a public modulus and reducing modulo a key modulus, and deriving the first cryptographic key from the result of the reduction modulo the key modulus.

In such examples, the local key material has typically been obtained from a substantially symmetric polynomial, and this allows both communication units in a pair to obtain the same shared key. Because an obfuscating number has been added to the local key material, the relation between the local key material and the root key material has been disturbed, i.e. there is no longer full symmetry. The relation that would be present between the un-obfuscated univariate polynomial and the symmetric bivariate polynomial is no longer present. This means that the straightforward attack on such a scheme no longer works.

The approach may e.g. be used as a cryptographic method for security protocols such us IPSec, (D)TLS, HIP, or ZigBee. In particular, a communication unit using one of those protocols is associated with an identifier. The identifier may be a network address such as the ZigBee short address, an IP address, or the host identifier. The identifier can also be an IEEE address of a device or a proprietary bit string associated with the device so that a device receives some local key material associated with the IEEE address during manufacturing.

Deriving a shared key may be used for many applications. The shared key may be used for confidentiality, e.g., outgoing or incoming messages may be encrypted with the shared key. Only a device with access to both identity numbers and one of the two local key materials will be able to decrypt the communications. The shared key may be used for authentication, e.g., outgoing or incoming messages may be authenticated with the symmetric key. In this way the origin of the message may be validated. Only a device with access to both identity numbers and one of the two local key materials will be able to create authenticated messages.

In accordance with an optional feature of the invention, the method further comprises: generating data using the second cryptographic key; and transmitting the data to the second communication unit.

This may allow the second communication unit to determine the shared key. The data may for example be data encrypted using the second cryptographic key and/or may e.g. be a cryptographic hash generated using the second cryptographic key.

In accordance with an optional feature of the invention, the step of generating comprises generating the perturbation value in response to the identity for the second communication unit.

This may provide a particularly advantageous perturbation value in many embodiments. In particular, it may increase security in some embodiments, and may e.g. be used to ensure that perturbation values are different for different communication units thereby increasing uncertainty and hindering collusion attacks.

In accordance with an optional feature of the invention, determining the perturbation value comprises determining the perturbation value as a function of the second communication unit identity.

This may provide a particularly advantageous perturbation value in many embodiments. In particular, it may increase security in some embodiments, and it may be used to ensure that perturbation values are different for different communication units, thereby increasing uncertainty and hindering collusion attacks. It may furthermore reduce complexity as a new shared key needs not be determined for each new communication session. In some embodiments, the perturbation value may be uniquely determined from the identity.

In accordance with an optional feature of the invention, the perturbation value is generated as a random value with a probability distribution.

This may allow a low complexity approach and may introduce a high degree of uncertainty thereby making collusion attacks substantially more difficult.

The probability distribution will typically limit the perturbation value to values that are relatively small compared to the key length.

The distribution may have a non-zero mean.

In accordance with an optional feature of the invention, the probability distribution is confidential to the first communication unit.

This may improve security. In particular, in many embodiments, the probability distribution that is used to generate the perturbation value is not (fully) known externally to the first communication unit. At least one characteristic of the probability function may in such embodiments be a secret of the first communication unit. This may ensure that multiple key setups and statistical operations cannot be used to estimate the effect of the perturbation value. For example, repeated key setups by an attacking communication unit could be averaged by the attacking communication unit. If the attacking unit would know the mean of the probability distribution, it could determine the first cryptographic key for a given identity by averaging multiple second cryptographic keys generated from repeated key establishments with that identity and subtracting the mean value. However, if the mean of the distribution is unknown to the attacking unit, this approach cannot be used.

In accordance with an optional feature of the invention, the perturbation value has a magnitude of no more than 10% of a magnitude of the first cryptographic key.

This may allow facilitated operation in the second communication unit while ensuring a high degree of security. In some embodiments, the perturbation value advantageously has a magnitude of no more than 5%, or even 1%, of the magnitude of the first cryptographic key.

In accordance with an optional feature of the invention, the second cryptographic key is generated by a modular combination of the first cryptographic key and the perturbation value, the modular combination using a public modulus value.

This may facilitate operation. The public modulus may specifically correspond to a length of the second cryptographic key. The modulus combination may specifically be a modulus addition.

According to an aspect of the invention there is provided a method of operation for a first communication unit, the method comprising: obtaining local key material for the first communication unit, the local key material originating from a Trusted Third Party and defining a key generating function for generating a cryptographic key as a function of at least one identity; obtaining an identity for a second communication unit, the second communication unit being different from the first communication unit; determining a first cryptographic key from the key generating function based on the identity of the second communication unit; receiving data from the second communication unit, the data being generated using a third cryptographic key, the third cryptographic key being a combination of a perturbation value and a cryptographic key dependent on an identity of the first communication unit; determining a set of possible perturbation values for the second communication unit; determining a set of possible cryptographic keys from the set of possible perturbation values and the first cryptographic key; and selecting a shared cryptographic key for the second communication unit by performing a cryptographic operation in relation to the data using each of the cryptographic keys from the set of possible cryptographic keys, and selecting the shared cryptographic key as a cryptographic key of the set of possible cryptographic keys that meets a validity criterion for the cryptographic operation.

The invention may enable or facilitate a communication unit determining a key used by another communication unit based on a locally generated key. It will be appreciated that the comments previously provided, e.g. with respect to the key generating functions, apply equally to such a communication unit.

The data may for example be data encrypted using the third cryptographic key and/or may e.g. be a cryptographic hash generated using the third cryptographic key. The cryptographic operations may for example comprise decrypting the data using each of the cryptographic keys from the set of possible cryptographic keys. The validation criterion may be an indication of a validity of the decrypted data. The cryptographic operations may for example comprise generating a cryptographic hash using each of the cryptographic keys from the set of possible cryptographic keys. The validation criterion may be requirement that a match between a generated cryptographic hash and the cryptographic hash of the data meets a criterion.

In accordance with an optional feature of the invention, determining the set of possible cryptographic keys comprises further determining the possible cryptographic keys in response to a possible non-symmetry between the first cryptographic key and the cryptographic key dependent on the identity of the first communication unit.

This may provide improved operation and security. The possible non symmetry may be indicated by a set of possible differences between keys generated by the first key generating function and the cryptographic key dependent on the identity of the first communication unit which has been used to generate the data. For example, a maximum possible difference between the keys may be known. Based on the possible perturbation values and the possible non-symmetry differences, the total possible difference between the first cryptographic key and the cryptographic key dependent on the identity of the first communication unit may be determined. Possible cryptographic keys can then be generated by generating all possible keys that are obtained by modifying the first cryptographic key by values not exceeding the maximum difference.

According to an aspect of the invention there is provided a method of operation for a communication system comprising a plurality of communication units; the method comprising a first communication unit performing the steps of: obtaining local key material for the first communication unit, the local key material originating from a Trusted Third Party and defining a first key generating function for generating a cryptographic key as a function of at least one identity, obtaining an identity for a second communication unit, the second communication unit being different from the first communication unit, determining a first cryptographic key from the first key generating function based on the identity of the second communication unit, locally generating a perturbation value for the first cryptographic key, the perturbation value not being uniquely determined by data originating from the Trusted Third Party, determining a second cryptographic key by applying the perturbation value to the first cryptographic key, generating data using the second cryptographic key, transmitting the data to the second communication unit; and the second communication unit performing the steps of: obtaining local key material for the second communication unit, the local key material originating from a Trusted Third Party and defining a second key generating function for generating a cryptographic key as a function of at least one identity, obtaining an identity for the first communication unit, determining a third cryptographic key from the second key generating function based on the identity of the first communication unit; receiving the data from the first communication unit; determining a set of possible perturbation values for the first communication unit; determining a set of possible cryptographic keys by applying the set of possible perturbation values to the third cryptographic key; and selecting a shared cryptographic key for the first communication unit by performing a cryptographic operation on the data using each of the cryptographic keys of the set of possible cryptographic keys, and selecting the shared cryptographic key as a cryptographic key of the set of possible cryptographic keys that meets a validity criterion for the cryptographic operation.

According to an aspect of the invention there is provided a communication unit comprising: a processor for obtaining local key material for the communication unit, the local key material originating from a Trusted Third Party and defining a first key generating function for generating a cryptographic key as a function of at least one identity; a processor obtaining an identity for a different communication unit; determining a first cryptographic key from the first key generating function based on the identity; a generator for locally generating a perturbation value for the first cryptographic key, the perturbation value not being uniquely determined by data originating from the Trusted Third Party; and a processor for determining a second cryptographic key by applying perturbation value to the first cryptographic key

According to an aspect of the invention there is provided a communication unit comprising: a processor for obtaining local key material for the first communication unit, the local key material originating from a Trusted Third Party and defining a key generating function for generating a cryptographic key as a function of at least one identity; a processor for obtaining an identity for a different communication unit; a processor for determining a first cryptographic key from the key generating function based on the identity of the second communication unit; a receiver for receiving data from the different communication unit, the data being generated using a third cryptographic key, the third cryptographic key being a combination of a perturbation value and a cryptographic key dependent on an identity of the first communication unit; a processor for determining a set of possible perturbation values for the different communication unit; a processor for determining a set of possible cryptographic keys from the set of possible perturbation values and the first cryptographic key; and a selector for selecting a shared cryptographic key for the second communication unit by performing a cryptographic operation in relation to the data using each of the cryptographic keys from the set of possible cryptographic keys, and selecting the shared cryptographic key as a cryptographic key of the set of possible cryptographic keys that meets a validity criterion for the cryptographic operation.

According to an aspect of the invention there is provided a communication system comprising: a first communication unit comprising: a processor for obtaining local key material for the first communication unit, the local key material originating from a Trusted Third Party and defining a first key generating function for generating a cryptographic key as a function of at least one identity, a processor for obtaining an identity for a second communication unit, the second communication unit being different from the first communication unit, a processor for determining a first cryptographic key from the first key generating function based on the identity of the second communication unit, a generator for locally generating a perturbation value for the first cryptographic key, the perturbation value not being uniquely determined by data originating from the Trusted Third Party, a processor for determining a second cryptographic key by applying the perturbation value to the first cryptographic key, a data generator for generating data using the second cryptographic key; a transmitter for transmitting the data to the second communication unit; and

the second communication unit comprising: a processor for obtaining local key material for the second communication unit, the local key material originating from a Trusted Third Party and defining a second key generating function for generating a cryptographic key as a function of at least one identity, a processor for obtaining an identity for the first communication unit, a processor for determining a third cryptographic key from the second key generating function based on the identity of the first communication unit; a receiver for receiving the data from the first communication unit; a processor for determining a set of possible perturbation values for the first communication unit; a processor for determining a set of possible cryptographic keys by applying the set of possible perturbation values to the third cryptographic key; and a processor for selecting a shared cryptographic key for the first communication unit by performing a cryptographic operation on the data using each of the cryptographic keys of the set of possible cryptographic keys, and selecting the shared cryptographic key as a cryptographic key of the set of possible cryptographic keys that meets a validity criterion for the cryptographic operation.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 is an illustration of a communication setup comprising a plurality of communication units;

FIG. 2 is an illustration of elements of a communication unit in accordance with some embodiments of the invention;

FIG. 3 is an illustration of elements of a communication unit in accordance with some embodiments of the invention;

FIG. 4 is an illustration of elements of a method of operation for a communication unit in accordance with some embodiments of the invention;

FIG. 5 is an illustration of elements of a method of operation for a communication unit in accordance with some embodiments of the invention;

FIG. 6 is an illustration of elements of elements of a Trusted Third Party for a communication network; and

FIG. 7 is an illustration of elements of elements of a Trusted Third Party for a communication network.

### DETAILED DESCRIPTION OF SOME EMBODIMENTS OF THE INVENTION

While this invention is susceptible of embodiment in many different forms, there is shown in the drawings and will herein be described in detail, some specific embodiments, with the understanding that the present disclosure is to be considered as exemplary and is not intended to limit the invention to the specific embodiments shown and described.

The following description focuses on embodiments of the invention applicable to a wireless communication system. However, it will be appreciated that the invention is not limited to this application but may be applied to fully or partially wired communication systems, including for example the Internet.

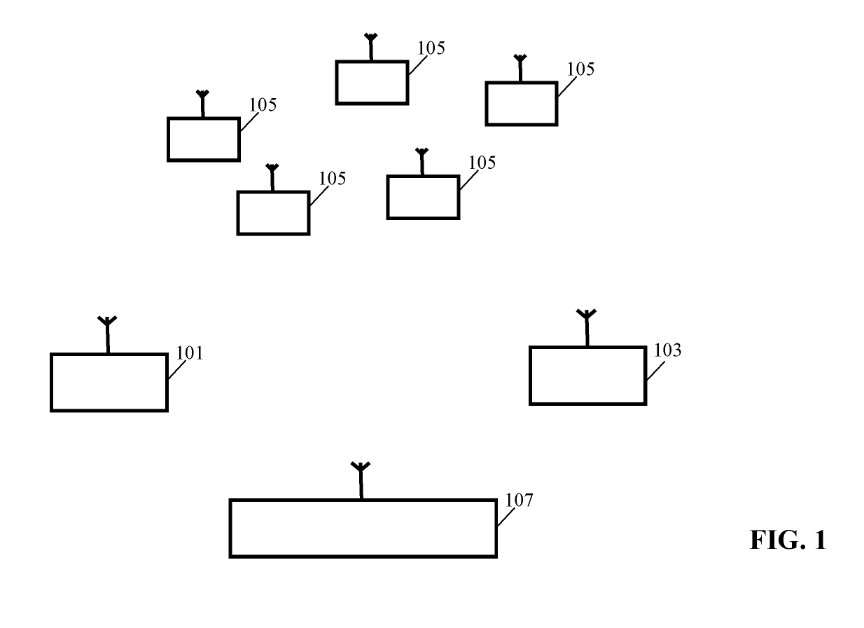

FIG. 1 illustrates an example of a wireless communication system in accordance with some embodiments of the invention.

The wireless communication system comprises a first communication unit 101 (or network device) and a second communication unit 103 (or network device) which seek to communicate data securely and privately using a shared cryptographic key. The data communication between the first communication unit 101 and the second communication unit 103 is performed via a wireless communication link which specifically may be a Wi-Fi communication link. For example, the first communication unit 101 or the second communication unit 103 may be a Wi-Fi access point and the other unit may be a mobile communication unit supported by the access point.

The Wi-Fi communication link may be a communication link that complies with the family of Wi-Fi communication standards such as e.g. one of the IEEE 802.11a, IEEE 802.11b, IEEE 802.11g, IEEE 802.11n, IEEE 802.11ac and IEEE 802.11ad standards. The Wi-Fi communication link may specifically support an IEEE 802.11 standards based communication.

In the example, the first communication unit 101 and second communication unit 103 seek to exchange confidential information that should not be retrievable by any third party. Accordingly, the first communication unit 101 and second communication unit 103 use encryption of data exchanged on the communication link. In order to perform such encryption, the first communication unit 101 and second communication unit 103 use a shared cryptographic key. Alternatively or additionally, the shared cryptographic key may be used to authenticate exchanged data, e.g. by generating cryptographic hashes.

In the example of FIG. 1, a cluster of communication devices 105 are able to receive the wireless communications between the first communication unit 101 and the second communication unit 103. In the specific example, the cluster of communication devices 105 cooperate and seek to determine the underlying key generating functions used by the first communication unit 101 in order to e.g. access the confidential communication exchanged between the first and second communication units 101, 103. Thus, the cluster of communication devices 105 are arranged to share information in order to attempt to compromise the security and confidentially of the communication between the first and second communication units 101, 103. Also, the cluster of communication devices 105 may potentially attempt to obtain information by setting up secure communications directly with the first communication unit 101 and/or the second communication unit 103.

In the system of FIG. 1, the distribution and control of cryptographic key information is controlled by a Trusted Third Party 107 which in the specific example is a central cryptography server, The Trusted Third Party 107 is a trusted entity which provides data defining how an encryption key to be used by the receiving communication unit should be calculated. Thus, the Trusted Third Party 107 distributes information on how the individual communication units should generate the cryptographic keys used for secure communication. The Trusted Third Party 107 is controlled and operated by an organization that is trusted and considered to be reliable. Thus, communication units operate under the assumption that the key material received from the Trusted Third Party 107 is reliable and can be trusted to define an approach for generating cryptographic keys that have not been compromised.

The communication between the Trusted Third Party 107 and the communication units are furthermore performed securely such that other communication units cannot access the information. Approaches for securely distributing key material from a Trusted Third Party 107 to individual communication units will be known to the skilled person and will for brevity not be described further herein.

In the system of FIG. 1, the Trusted Third Party 107 is a central cryptography server which may communicate wirelessly with the communication units in order to provide local key material which defines a function for generating cryptographic keys. In other embodiments, the local key material may be provided by other means, such as for example through a wired communication network or via a media, such as a removable memory. In yet other embodiments, the local key material may be provided during manufacturing and stored in the individual communication units (indeed it may be hardwired into the communication units).

In the example, the key material provided to a communication unit uniquely defines a function that describes how the individual communication unit should generate cryptographic keys. Specifically, the local key material uniquely defines a function for how to generate a cryptographic key as a function of one or more identities. Specifically, the function may define how to generate a cryptographic key from a single communication unit identity, and may thus be a univariate function. Thus, the key material provided to a given communication unit X may define how communication unit X should derive a cryptographic key for use with another communication unit Y, i.e. it may define a function Kₓ(Y).

Firstly, symmetric functions will be considered, i.e. where the distributed key material may define functions that are pairwise symmetric, i.e. for which:

K_{X}(Y)=K_{Y}(X)

holds for all pairs of communication units.

Conventionally, two communication units seeking to communicate securely may in such cases simply determine the shared cryptographic key by evaluating their own cryptographic generating function using the communication unit identity of the other communication unit. As these approaches will individually result in keys that are identical, communication can proceed by e.g. encrypting data using this shared cryptographic key.

The key generating functions defined by the Trusted Third Party 107 have the property that they are relatively easy to evaluate in one direction, but very difficult to determine from the resulting cryptographic key. Indeed, even if a third party knows the communication unit identity for a unit and the corresponding encryption key, he will not be able to determine the underlying key generating function that has been used.

For example, if one of the attacking cluster of communication devices 105 establishes a secure communication with the first communication unit 101, it will obtain knowledge of a corresponding identity and it can locally determine the cryptographic key for this identity, which will also correspond to the cryptographic key that the first communication unit 101 will generate based on its local key generating function and the identity of the attacking communication unit. However, it cannot from this key determine the underlying key generating function used by the first communication unit 101 and therefore cannot determine the cryptographic key that the first communication unit 101 will generate when communicating with the second communication unit 103.

Specifically, denoting the first communication unit 101 by A, the second communication unit 103 by B, and the cluster of communication devices 105 by C,D,E etc., one of the communication units of the cluster of communication devices 105 may establish a shared key with device A. Thus, it may determine the key K_{C}(A) which will be identical to the key K_{A}(C). However, even knowing K_{A}(C), the attacking communication unit 105 cannot determine K_{A}(x), i.e. it cannot determine the underlying key generating function. Therefore, it cannot either determine the cryptographic key K_{A}(B), and thus cannot determine the shared key for communication between the first communication unit 101 and the second communication unit 103.

However, if a number of communication units are working together to perform a so called collusion attack, substantially more information can be gathered by the attacking party. For example, if all communication units of the cluster of communication devices 105 determine a shared key for the first communication unit 101, a number of cryptographic keys will be known, i.e. the attacking party will have knowledge of K_{A}(C), K_{A}(D), K_{A}(E), K_{A}(F) etc.

It can be shown that if enough of such shared keys are known, it may be possible in some systems to determine the key generating function K_{A}(x) and accordingly the shared key K_{A}(B). Thus, in some systems, it may be possible for a collusion attack to compromise the security and confidentiality of communication.

The approach may be made more difficult if the system uses key generating functions in the communication units that are not guaranteed to be perfectly symmetric but typically only to be approximately symmetric, i.e. such that only

K_{X}(Y)≈K_{Y}(X)

holds for all pairs of X and Y. The asymmetry may for example be introduced by adding a value (referred to as an obfuscating value or number) to corresponding functions that are fully symmetric. For example, the Trusted Third Party may determine a set of pairwise symmetric functions and then add different obfuscating values to these functions to generate functions that are not fully symmetric.

Such an approach may prevent that colluding attacking communication units simply use the locally generated key K_{C}(A), K_{D}(A), K_{E}(A), K_{F}(A) as a sample point for the first key generating function, i.e. as K_{A}(C), K_{A}(D), K_{A}(E), K_{A}(F). As there may be a difference between the corresponding calculated keys, the approach for determining K_{A}(x) must be expanded to include all possible differences. This may result in a significant increase in complexity and may render the attack impractical.

In order for the intended two communication units to agree on a shared cryptographic key, an additional process must be performed to align the two locally generated cryptographic keys. An example of such a system can be found in U.S. application 61/649,464 filed on 21 May 2012 (attorney docket 2012PF00717). In this approach, a process can be used to determine a shared key, e.g. by identifying parts of the generated keys that are identical by iterative communications that are based on e.g. discarding least significant bits of the cryptographic key until a match is found. This allows the difference between the cryptographic keys resulting from asymmetric key generating functions to be determined.

However, in some systems it cannot be guaranteed that communication units may not perform key setup routines with potentially attacking communication units. For example, in some systems, any communication unit may initiate a shared cryptographic key setup with any other communication unit. In this case, the difference between the locally generated functions can be determined by an attacking communication unit, i.e. the effect of the obfuscating value may be determined and thus removed. Thus, in such a scenario, each attacking communication unit may again be able to determine a single cryptographic key generated by the key generating function under attack. Thus, the uncertainty introduced by the lack of perfect symmetry can be resolved by the attacking communication units.

In the system of FIG. 1, the first communication unit 101 and second communication unit 103 use a modified key generating approach which allows for improved robustness and security against collusion attacks.

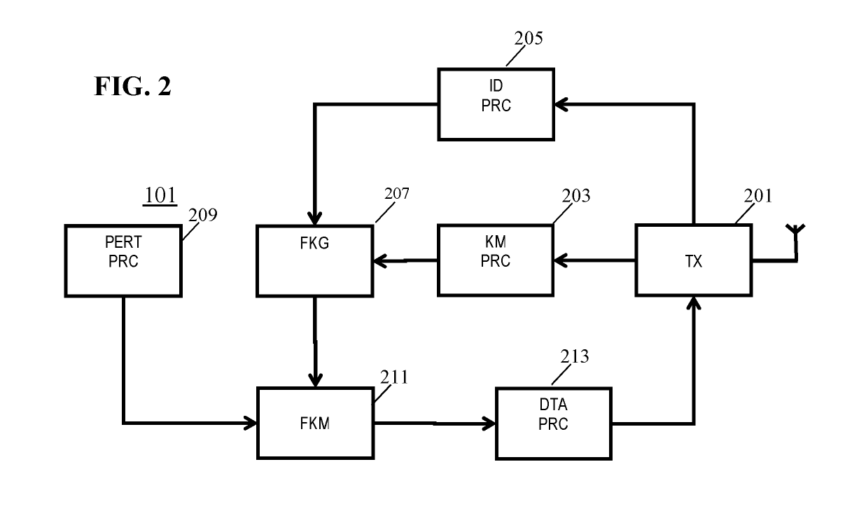

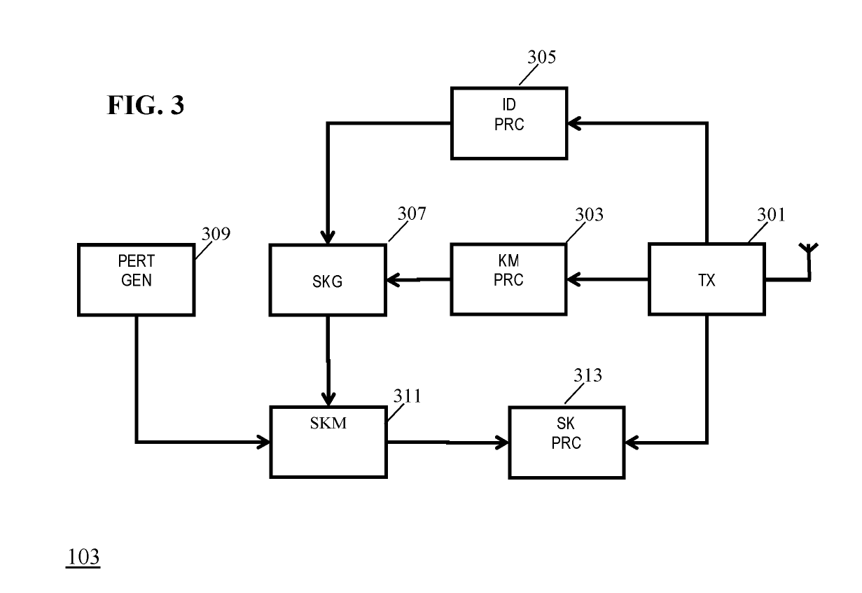

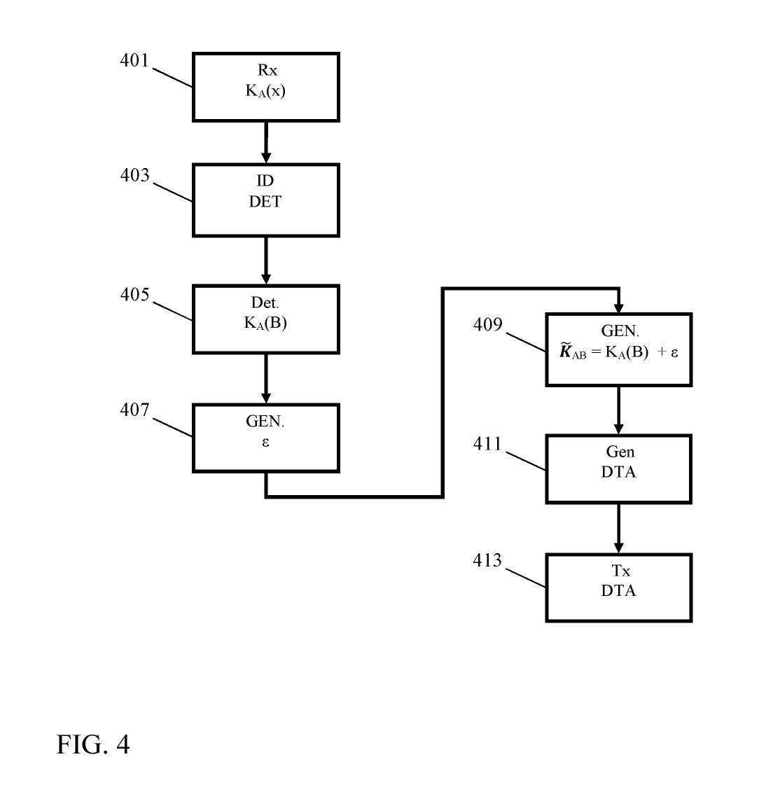

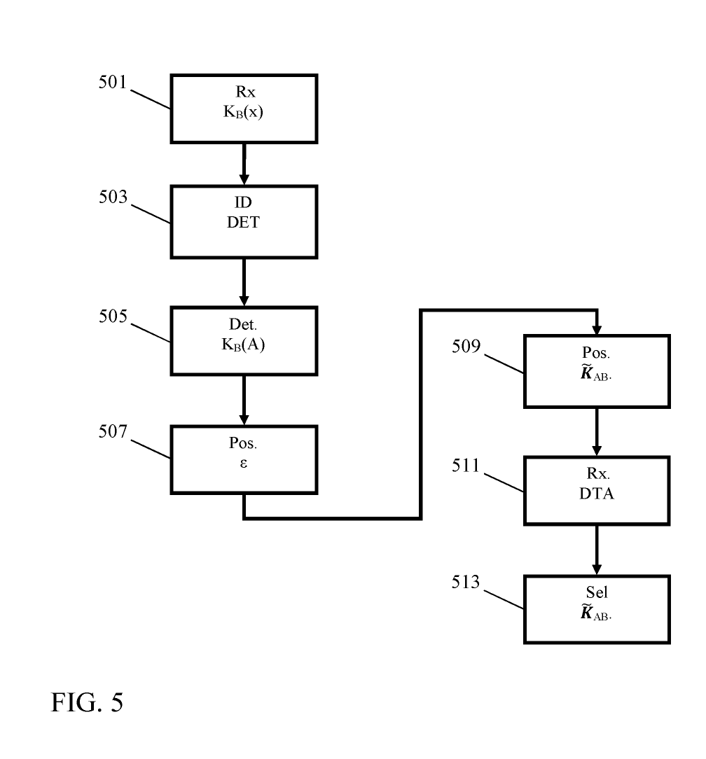

FIG. 2 illustrates elements of the first communication unit 101 and FIG. 3 illustrates elements of the second communication unit 103. FIG. 4 illustrates an example of a method for determining a shared key by the first communication unit 101 and FIG. 5 illustrates an example of a method for determining a shared key by the second communication unit 103.

The first communication unit 101 comprises a first wireless transceiver 201 which is arranged to communicate with other communication units over the air interface. In particular, the first wireless transceiver 201 can communicate with the Trusted Third Party 107 and the third communication unit 105 via wireless radio transmissions. In the specific example, the over the air communications may be WiFi communications, and thus the first wireless transceiver 201 may be arranged to operate in accordance with the WiFi communication standards. It will be appreciated that in other embodiments, the first communication unit 101 (and indeed the second communication unit 103) may receive data from the Trusted Third Party 107 via a wired medium or a portable medium, such as a memory card. In yet other embodiments, the data (and specifically the key material) may be provided by the Trusted Third Party 107 during manufacturing, and may be programmed into the communication units at this time.

The first wireless transceiver 201 is coupled to a first key material processor 203 which performs step 401 in which it obtains local key material that has originated at the Trusted Third Party 107. In the specific example, the local key material is received by a (secure) wireless communication from the Trusted Third Party 107 but it will be appreciated that in other embodiments in may be obtained from other sources, including both internal and external sources. For example, the local key material may be provided by the Trusted Third Party 107 during manufacture and stored in a local storage of the first communication unit 101. As another example, it may be provided from a suitable portable media, such as a detachable memory (e.g. a memory card or USB).

The local key material uniquely defines a first key generating function which can be used to generate cryptographic keys required to support secure cryptographic operations. The first key generating function is specific to the specific communication unit, i.e. the first key generating function for the first communication unit 101 is different from key generating functions used by other communication units. The first key generating function provides a cryptographic key based on an input of one or more identities of communication units (or equivalently identities of users associated with communication units).

The following example will focus on embodiments wherein the first key generating function is a univariate function of the identity of the communication unit for which the shared key is determined. Thus, the first key generating function is given as: K_{A}(x) where index A indicates the first key generating function and x represents an input identity for generating the cryptographic key.

It will however be appreciated that in some embodiments, the first key generating function may be a function of two or more identities. For example, if three communication units set up a three way secure communication using a single shared key, the first key generating function may be defined as one that can provide a cryptographic key based on the two identities of the other communication units that are to be involved in the communication.

In the example, the local key material uniquely defines the first key generating function, i.e. based on the local key material a cryptographic key is uniquely defined for each possible identity (or set of identities if the first key generating function is a function of a plurality of identities). In the specific embodiment, the local key material defines a polynomial which is used to generate a cryptographic key as will be described in more detail later.

Thus, in step 401 the first key material processor 203 obtains local key material uniquely defining a first key generating function.

The first communication unit 101 furthermore comprises a first identity processor 205 which is arranged to execute step 403 wherein the first communication unit 101 determines an identity of a communication unit with which a secure communication is being initialized, i.e. for which a shared cryptographic key should be determined. In the specific example, the first identity processor 205 is thus arranged to determine the identity of the second communication unit 103.

It will be appreciated that the second communication unit identity may be determined in any suitable way, such as e.g. in response to a communication setup request from the second communication unit 103 itself or e.g. in response to a user input to the first communication unit 101 etc.

The first key material processor 203 and the first identity processor 205 are coupled to a first key generator 207 which is arranged to perform step 405 wherein a first cryptographic key is determined using the first key generating function and the determined identity of the second communication unit 103 (referred to as identity B). Thus, the first key generator 207 calculates the first key generating function using identity B as the input thereby generating a first cryptographic key, i.e. the first key generator 207 calculates the value K_{A}(B).

In conventional systems, the generated first cryptographic key is typically used directly as the shared key with the other communication unit separately calculating the shared key based its own key generating function and with the identity of the first communication unit 101 as an input. In conventional systems, the key generating functions are symmetric. In the example, the key generating functions, however, are selected from a set of non-symmetric, but approximately symmetric functions. Specifically, the key generating functions are functions generated by adding different obfuscating values to functions of a set of symmetric key generating functions.

Furthermore, in the system of FIG. 1, the first cryptographic key generated by the first key generating function is not used as the shared key but rather a locally generated perturbation value is generated and typically added to the key generated from the first key generating function to generate the shared key.

Specifically, the first communication unit 101 comprises a first perturbation value generator 209 which is arranged to perform step 407 which generates a perturbation value E. The perturbation value may for example be generated as a random value within a given probability distribution, such as a uniform distribution with a maximum magnitude substantially smaller than a maximum possible magnitude of the first key generating function.

The first perturbation value generator 209 and the first key generator 207 are coupled to a first key modifier 211 which performs step 409 wherein the first cryptographic key is modified in response to the perturbation value thereby generating a second cryptographic key. This second cryptographic key is then used as the shared key for secure communications with the second communication unit 103.

The second cryptographic key may specifically be generated as:

\tilde{K}_{AB}=K_{A}(B)+ε

In the system of FIG. 1, the perturbation value is locally generated and is only known by the first communication unit 101. Indeed, the perturbation value is not even known to the Trusted Third Party 107 and is not uniquely defined by any information originating at the Trusted Third Party 107. Thus, at least part of the perturbation value cannot be determined from information originating from the Trusted Third Party 107.

The first key modifier 211 may specifically add the perturbation value to the first cryptographic key (typically using modular addition) to generate the shared key. Thus, rather than use the cryptographic key uniquely determined by the local key material and the identity of the second communication unit 103, the use of the perturbation value introduces a deviation which is generally unknown in the system, and which specifically will be unknown to any potential attackers. As an example, a small random value may be added to each generated key whenever a new communication is set-up thereby generating a (possibly) new key for each communication set-up.

This approach introduces uncertainty for third parties with respect to the shared key. Indeed, whereas in traditional systems, a third party can assume that all shared keys are generated from the set of pairwise symmetric functions, this cannot be assumed for the system of FIG. 1. Rather, the shared keys may deviate from the ones generated using the key generating functions. This results in a substantially increased difficulty in determining the underlying key generating functions even if many examples of shared keys where known. Indeed, even if colluding attacking communication units share information about generated shared keys (i.e. K_{A}(C), K_{A}(D), K_{A}(E), K_{A}(F) etc.), the added uncertainty renders the processing required to determine the underlying function K_{A}(x) from such keys so complex that it is in practice not possible to solve the problem.

Accordingly, the addition of an additional perturbation/deviation/noise value to the generated first cryptographic key provides substantially increased protection against collusion attacks, and indeed in many practical applications renders collusion attacks impractical or indeed virtually impossible.

Furthermore, in the example, the difference between the cryptographic keys generated by two communication units, i.e. the difference between the results of the shared key and the result of the key generating function in the communication unit not adding the perturbation value, is made up of the difference between the key generating functions and the added perturbation value. The perturbation value will be unknown to the other communication unit, and whereas this unit may possibly determine the differences between the shared key and its local key, it cannot determine how much of this is due to the perturbation value and how much is due to the asymmetry between the two key generating functions. Accordingly, it cannot uniquely determine the cryptographic key generated by the generating function of the communication unit generating the shared key. Therefore, a single sample of a correlation between an identity and a cryptographic key for the key generating function cannot be determined.

In other words, an attacking communication unit may locally generate a cryptographic key for a communication unit under attack, e.g. it may calculate K_{C}(A). In some scenarios, it may further interact with the attacked communication unit to determine the shared key, e.g. it may determine \tilde{K}_{AC}=K_{A}(C)+ε. However, due to the lack of perfect symmetry (e.g. due to the obfuscating value) K_{A}(C) is unknown even if K_{C}(A) is known. Furthermore, even if processes are performed to align the generated cryptographic keys, i.e. such that both the locally generated key K_{C}(A) and the shared key \tilde{K}_{AC} are known, the uncertainty of the perturbation value ε means that K_{A}(C) still cannot be determined thereform. Thus, even if key disambiguation is performed, this still does not allow the key generated by the key generating function to be determined. Rather, the uncertainty of the key K_{A}(C) will be as large as the uncertainty of the perturbation value ε. Any process trying to determine the key generating function K_{A}(x) from a plurality of determined shared keys \tilde{K}_{AC}, \tilde{K}_{AD}, \tilde{K}_{AE}, \tilde{K}_{AF} must for each shared key consider all possible values of the perturbation value E. This substantially increases the complexity of the task by substantially increasing the number of unknowns. In practice, such an approach will render it virtually impossible to determine the underlying key generating function.

The perturbation value must however also be considered when determining a shared key between the two intended parties. Indeed, due to the perturbation value, the cryptographic key generated at the first communication unit 101, i.e. K_{A}(B), is not identical to the cryptographic key generated at the second communication unit 103, i.e. K_{B}(A). Accordingly, the second communication unit 103 need to perform an operation in order to determine the shared key from the cryptographic key K_{B}(A).

The process involves the first communication unit 101 transmitting data to the second communication unit 103 with the data being generated based on the shared cryptographic key, i.e. based on \tilde{K}_{AC}.

Specifically, the first key modifier 211 is coupled to a data processor 213 which is provided with the second cryptographic key/shared cryptographic key. The data processor 213 is arranged to execute step 411 wherein data is generated using the shared cryptographic key.

The data processor 213 is further coupled to the first wireless transceiver 201 which is fed the generated data and which proceeds to execute step 413 wherein the data is transmitted to the second communication unit 103.

The data, henceforth referred to as the cryptographic data, may for example be data that has been encrypted using the shared cryptographic key. As another example, the cryptographic data may be a cryptographic hash based on the generated shared key and possibly also on other data known to the second communication unit 103, e.g. on other data being transmitted to the second communication unit 103 in the clear, or on a nonce previously received from the second communication unit 103, or on predetermined and possibly standardized data.

The second communication unit 103 comprises a second wireless transceiver 301 which is arranged to communicate with other communication units, including the first communication unit 101 and in the example the Trusted Third Party 107, over the air interface. The second wireless transceiver 301 may be similar or identical to the first wireless transceiver 201 and the comments provided thereto relate equally to the second wireless transceiver 301.

The second communication unit 103 comprises a second key material processor 303 which is coupled to the second wireless transceiver 301 and which is arranged to perform step 501 in which it obtains local key material that has originated at the Trusted Third Party 107.

In the specific example, the local key material is received by a (secure) wireless communication from the Trusted Third Party 107 but it will be appreciated that in other embodiments in may be obtained from other sources, including both internal and external sources. For example, the local key material may be provided by the Trusted Third Party 107 during manufacture and stored in a local storage of the first communication unit 101. As another example, it may be provided from a suitable portable media, such as a detachable memory (e.g. a memory card or USB).

The local key material defines a second key generating function K_{B}(x) which can be used to generate cryptographic keys required to support secure cryptographic operations. The second key generating function is specific to the second communication unit 103 and provides a cryptographic key based on an input of one or more identities of communication units (or equivalently identities of users associated with communication units).

The second key generating function is in the example another function of the set of pairwise substantially symmetric key generating functions distributed by the Trusted Third Party 107. In the example, the second generating function is thus a univariate function of a communication unit (or user) identity which is approximately but not fully symmetric with the first key generating function provided to the first communication unit 101, i.e. K_{A}(B)≈K_{B}(A)

In the example, the local key material uniquely defines the first key generating function.

In the specific embodiment, the local key material defines a polynomial which is used to generate a cryptographic key.

Thus, in step 501 the second key material processor 303 obtains local key material uniquely defining a first key generating function.

The second communication unit 103 furthermore comprises a second identity processor 305 which is arranged to execute step 503 wherein the second communication unit 103 determines the identity of the first communication unit 101, i.e. it determines the identity of the communication unit with the secure communication is being initialized.

It will be appreciated that the first communication unit identity may be determined in any suitable way, such as e.g. in response to a message being received from the first communication unit 101.

The second key material processor 303 and the second identity processor 305 are coupled to a second key generator 307 which is arranged to perform step 505 wherein a third cryptographic key is determined using the second key generating function and the determined identity of the first communication unit 101 (referred to as identity A). Thus, the second key generator 307 calculates the third key generating function using identity A as the input to the second key generating function, i.e. the second key generator 307 calculates the value K_{B}(A).

In conventional systems, the keys K_{A}(B)=K_{B}(A) are used as the shared key and thus the third cryptographic key could directly be used as the shared key. However, in the present example, the first communication unit 101 generates the shared key by modifying the first cryptographic key K_{A} (B) by the perturbation value and furthermore the key generating functions are not symmetric, i.e. K_{A}(B)≠K_{B}(A). Therefore, the second communication unit 103 proceeds to determine the modification to the third cryptographic key K_{B}(A) corresponding to the perturbation value and the asymmetry.

Specifically, the second communication unit 103 comprises a second perturbation value generator 309 which is arranged to perform step 507 wherein a set of possible perturbation values that may have been used by the first communication unit 101 is generated.

Typically, the possible perturbation values that may be used by a communication unit may be predetermined in the system. For example, it may be standardized that a perturbation value is an additive value that has a maximum magnitude of Pₘₐₓ, i.e. that the perturbation value belongs to the interval [−Pₘₐₓ, Pₘₐₓ]. The range is typically much smaller than the magnitude of the cryptographic keys. Indeed, in many embodiments Pₘₐₓ is no more than 10% of the largest magnitude possible of the first and/or second cryptographic key.

In many embodiments, the set of possible perturbation values may simply consist of all possible values, such as all integers in the range of [−Pₘₐₓ, Pₘₐₓ].

The second perturbation value generator 309 and the second key generator 307 are coupled to a second key modifier 311 which receives the set of possible perturbation values and the third cryptographic key K_{B}(A).

The second key modifier 311 proceeds to perform step 509 wherein the set of possible communication unit perturbation values are combined with the third cryptographic key to generate possible cryptographic keys. The same approach is used as used by the first communication unit 101 when applying the selected perturbation value to the first cryptographic key to generate the shared key. Specifically, a modular addition may be performed where the modulus corresponds to the key length (specifically 2^{N} where N is the key length).

Furthermore, the second key modifier 311 proceeds to consider the possible non-symmetry between the cryptographic keys generated by the key generating function of the first communication unit 101 and the key generating function of the second communication unit 103. Indeed, since the first key generating function and the second key generating function are not symmetric, there will be a difference between the resulting keys. Typically, the maximum value of this difference is known, and the second key modifier 311 will proceed to add this possible difference to the possible cryptographic keys thereby generating a larger set of possible cryptographic keys.

For example, if the Trusted Third Party 107 may introduce an additive offset with a maximum magnitude of Δ and the first communication unit 101 may introduce a maximum perturbation value of Pₘₐₓ, then the second communication unit 103 can determine that the maximum difference between the locally generated third cryptographic key and the shared cryptographic key is 2·Δ+Pₘₐₓ. Thus, the set of possible shared cryptographic keys may include all keys that are generated by adding an integer from the range [−2·Δ+Pₘₐₓ, 2·Δ+Pₘₐₓ] to the locally generated third cryptographic key.

Thus, the second key modifier 311 generates a set of possible shared cryptographic keys. Thus, one of the generated cryptographic keys will correspond to the shared key but it is unknown which one.

The second key modifier 311 is coupled to a shared key processor 313 which is also coupled to the second wireless transceiver 301. The second wireless transceiver 301 is arranged to perform step 511 wherein the cryptographic data generated by the first communication unit 101 is received. Thus, the second wireless transceiver 301 receives the cryptographic data that the first communication unit 101 generated using the shared cryptographic key. This data is fed to the shared key processor 313.

The shared key processor 313 is arranged to perform step 513 wherein a cryptographic operation is performed on the received cryptographic data for each of the possible shared cryptographic keys. For each of the possible shared cryptographic keys, a cryptographic operation is thus applied to the received cryptographic data using the possible cryptographic key. The cryptographic operation corresponds to that which was performed by the first communication unit 101. For example, it may be an inverse operation, such as decryption, or the same operation, such as determining a cryptographic hash.

The outcome of the individual cryptographic operation is then evaluated to determine whether the result of the operation is valid or not. Specifically, the cryptographic operation will be valid if it is performed using the same cryptographic key as was used to originally generate the data.

It will be appreciated that the specific cryptographic operation and the specific validity criterion that is used will depend on the specific embodiment and on the operation performed at the first communication unit 101.

For example, if the cryptographic data is encrypted data, the shared key processor 313 performs a decryption operation using each of the possible cryptographic keys. For each of the keys, the validity of the operation is determined by whether the decryption is successful.

Specifically, if the decryption results in valid data (e.g. having a correct checksum, matching known characteristics etc), the cryptographic operation is considered to be valid and otherwise it is not.

As another example, the cryptographic data may be a cryptographic hash generated using the shared cryptographic key. A corresponding cryptographic hash may be generated for each of the possible shared cryptographic keys and the resulting hashes may be compared to the received one. The cryptographic operation may be considered valid when the hashes match, and otherwise the cryptographic operation is considered as invalid.

The shared key processor 313 then proceeds to select one of the possible shared cryptographic keys based on the validity measures. Specifically, the shared key processor 313 selects the key for which the highest validity indication was found, e.g. the key is selected as the possible shared cryptographic key that results in a successful decryption or a matching hash.

Thus, the second communication unit 103 proceeds to determine the same shared cryptographic key as was generated by the first communication unit 101. The shared key may subsequently be used for secure communication between the first communication unit 101 and the second communication unit 103.

Although the approach may increase the complexity of the determination of the shared cryptographic key, the complexity is relatively low as the uncertainty of the perturbation value can be kept relatively low.

However, for a collusion attack which typically requires a relatively high number of communication units, the uncertainty introduced to the shared key may result in substantially increased number of possible permutations and therefore substantially increase capacity.

In the example, the key generating functions may belong to a set of functions that are not necessarily symmetric but are only guaranteed to be substantially symmetric, i.e.

Kₓ(y)≈K_{y}(x).

For example, the Trusted Third Party 107 may be arranged to introduce a modification to functions belonging to a set of symmetric function when assigning these functions to the individual communication units.

For example, the Trusted Third Party 107 may select a function from a set of functions that are symmetric. Before distributing such a function to a communication unit, it may introduce a perturbation value/obfuscating value to the function. Specifically, when allocating each function to the communication units, a small value is e.g. added to the function. The individual functions are accordingly offset relative to the fully symmetric function.

The shared key may be determined taking this deviation into account. Specifically, the set of possible shared keys may be generated taking into account both the perturbation value that may be included by the first communication unit 101 but also the deviations that may be introduced by the Trusted Third Party 107 to fully symmetric functions in order to generate the first generating function as well as the second generating function.

Different approaches may be used for generating the perturbation value in different embodiments.

In many embodiments, the perturbation value may simply be generated as a new random value each time a new shared key setup is performed. The perturbation value may thus simply be generated as a random value selected in accordance with a given probability distribution.

For example, the perturbation value may be determined from a uniform distribution in a range of [−Pₘₐₓ, Pₘₐₓ]. The use of random values increases the uncertainty of the deviation from the symmetric function and may make it significantly more difficult to perform a collusion attack.

In many embodiments, the distribution will be selected to have a non-zero mean. For example, the random value may be generated from a non-zero mean uniform distribution, such as e.g. from a uniform distribution in a range of [−Pₘₐₓ+1, Pₘₐₓ+1].

The use of a non-zero mean random value may provide increased security in many scenarios. In particular, the non-zero mean may provide increased protection against each of the attacking communication units repeatedly initializing new shared key exchange setups and averaging the resulting shared keys to get an average value corresponding to the cryptographic key generated by the first key generating function applied by the first communication unit 101. The use of an unknown probability distribution with an unknown mean, results in the attacking communication unit not being able to merely average such multiple key generations. In other words, even if an attacking communication unit performed a large number of key establishments in order to determine a mean value for the shared key between the first communication unit 101 and the attacking communication unit, this mean value can still not be used to uniquely determine the first cryptographic key since the mean of the probability distribution generating the perturbation value is not known. For example, even if the attacking communication unit determines the mean shared cryptographic key, it cannot assume that this mean key corresponds to the first cryptographic key unless it is known that the average perturbation value is zero.

Thus, more generally, the probability distribution may confidential to the first communication unit 101 and may not be fully known externally to the first communication unit 101. In particularly, the mean of the probability distribution may not be known externally of the first communication unit 101.

In some embodiments, the perturbation value may be generated in response to the identity of the second communication unit 103. Thus, the perturbation value p may be a function of the second communication unit 103 identity, i.e.

p=f(B).

As a specific example, the first time a shared key is established with the second communication unit 103, the first communication unit 101 may generate the perturbation value as a random value in the range from [−Pₘₐₓ, Pₘₐₓ]. The resulting perturbation value (or corresponding shared key) may be stored in the first communication unit 101. Similarly, when the second communication unit 103 has determined the shared cryptographic key it stores it locally. In subsequent communications between the first communication unit 101 and the second communication unit 103, the units may retrieve the stored values and use these. Thus, for the subsequent communication setups, the same shared key and the same perturbation value is accordingly used. Such an approach may prevent that statistical analysis can be used to estimate the underlying probability distribution used to generate the perturbation value.

However, the approach may also require a substantial amount of memory. Another approach may be to determine the perturbation value as a deterministic value of the identity of the second communication unit 103. As another example, the perturbation value may be determined as the x least significant bits of a cryptographic hash (or more in generally a pseudorandom function) which is generated using a random seed determined from the identity of the second communication unit 103.

Thus, in the system, the shared key is generated on the basis of a key generating function that is defined by the Trusted Third Party 107. However, rather than using this key directly, a perturbation value is added to the key with the perturbation value not being uniquely determined by the Trusted Third Party 107. Rather, the perturbation value is locally generated in the first communication unit 101 based on at least some information that is known only to the first communication unit 101. Specifically, the perturbation value may include a random element relative to any information provided by the Trusted Third Party 107. The exact value of the selected perturbation value is not known externally of the first communication unit 101.

The previous description focuses on an example wherein the first communication unit 101 generates the shared cryptographic key by adding the perturbation value, whereas the second communication unit 103 merely aligns its locally generated cryptographic key to this shared cryptographic key. However, it will be appreciated that in many embodiments both/all communication units may comprise functionality both for generating the shared key by adding a perturbation value, and to align its locally generated key to a shared key generated by another communication unit. Thus, the first communication unit 101 may also comprise the functionality described with reference to the second communication unit 103, and vice versa.

It will also be appreciated that the choice of which communication unit generates the perturbation value and the shared key may be determined in accordance with any suitable approach. For example, the communication unit instigating the communication setup may also be the communication unit which generates the shared cryptographic key.

In the following, a specific example of an approach for initializing key sharing will be described. In the example, the key sharing has a set-up phase and a use phase. The set-up phase may include initiation steps and registration steps. The initiation steps do not involve the communication units.

The initiation steps select system parameters. The initiation steps may be performed by the Trusted Third Party (TTP). However, the system parameters may also be regarded as given as inputs. In that case the TTP need not generate them, and the initiation steps may be skipped. For example, the TTP may receive the system parameters from a device manufacturer. The device manufacturer may have performed the initiation steps to obtain the system parameters. For convenience we will refer to the TTP as performing the initiation steps, bearing in mind that this is not necessary.

### Initiation Steps

The desired key length for the key that will be shared between devices in the use phase is selected; this key length is referred to as ‘b’. A typical value for b for a low security application may be 64 or 80. A typical value for a consumer level security may be 128. Highly secret applications may prefer b=256 or even higher values.

In the example, the key generating functions are polynomials.

The desired degree of the polynomials is selected; the degree controls the degree of certain polynomials. The degree will be referred to as ‘a’, it is at least 1. A practical choice for a is 2. A more secure application may use a higher value of a, say 3 or 4, or even higher. For a simple application also a=1 is possible. The case a=1 is related to the so called ‘hidden number problem’; higher “a” values are related to the extended hidden number problem confirming that these cases are hard to break.

The number of polynomials is selected. The number of polynomials will be referred to as ‘m’. A practical choice for m is 2. A more secure application may use a higher value of m, say 3 or 4, or even higher. Note that a low-complexity application, say for resource bounded devices may use m=1.

Higher values of security parameters a and m increase the complexity of the system and accordingly increase its intractability. More complicated systems are harder to analyze and thus more resistant to cryptanalysis.

In an embodiment, a public modulus N is selected satisfying 2^{(a+2)b-1}≦N and most preferably also N≦2^{(a+2)b}−1. The bounds are not strictly necessary; the system could also use a smaller/larger value of N, although that is not considered the best option.

Often the key length, degree and number of polynomials will be pre-determined, e.g., by a system designer, and provided to the trusted party as inputs. As a practical choice one may take N=2^{(a+}2)b−1. For example if a=1, b=64 then N may be N=2¹⁹²−1. For example if a=2, b=128 then N may be N=2⁵¹²−1. Choosing for N the upper or lower bound of the above interval has the advantage of easy computation. To increase complexity one may choose a random number within the range for N.

A number of m pairwise distinct private moduli p₁, p₂, . . . , pₘ, are selected. Moduli are positive integers. During the registration steps each device will be associated with an identity number. Each selected private modulus is larger than the largest identity number used. For example, one may bound identity numbers by requiring that they are less or equal to 2^{b}−1, and that the selected private moduli are larger than 2^{b}−1. Each selected number satisfies the following relationship pⱼ=N+γⱼ·2^{b}. Wherein the γⱼ are integers such that |γⱼ|<2^{b}. One practical way of selecting numbers that satisfy this requirement is to choose a set of m random integers γⱼ such that −2^{b}+1<γⱼ<2^{b}−1 and compute the selected private moduli from the relationship pⱼ=N+γⱼ·2^{b}. Having |γⱼ| a bit larger may be allowed, however, a problem may occur in that the modular operation goes too far so that shared keys might not be equal.

A number of m symmetric bivariate polynomials f₁, f₂, . . . , fₘ of degrees aⱼ are generated. All degrees satisfy aⱼ≦a, most preferably a=MAX{a₁, . . . , aₘ}. A practical choice is to take each polynomial of degree a. A bivariate polynomial is a polynomial in two variables. A symmetric polynomial f satisfies f(x, y)=f(y,x). Each polynomial fⱼ is evaluated in the finite ring formed by the integers modulo pⱼ, obtained by computing modulo pⱼ. The integers modulo pⱼ form a finite ring with pⱼ elements. In an embodiment the polynomial fⱼ is represented with coefficients from 0 up to pⱼ−1. The bivariate polynomials may be selected at random, e.g., by selecting random coefficients within these bounds.

The security of the key sharing depends on these bivariate polynomials as they are the root key material of the system; so preferably strong measures are taken to protect them, e.g., control procedures, tamper-resistant devices, and the like. Preferably the selected integers p₁, p₂, . . . , pₘ are also kept secret, including the value γⱼ corresponding to pⱼ, though this is less critical. We will refer to the bivariate polynomials also in the following form: for j=1, 2, . . . , m, we write fⱼ(x,y)=Σᵢ₌₀^{a}f_{i,j}(x)yⁱ.

The above example can be varied in a number of ways. The restrictions on the public and private moduli may be chosen in a variety of ways, and mays specifically be selected to obfuscate the univariate polynomial. This may specifically be used to generate keys based on the generating polynomials which are different but which remain sufficiently close to each other sufficiently often. As explained, what is sufficient will depend on the application, the required security level and the computing resources available at the communication units. The above embodiment combines positive integers such that the modular operations which are carried out when generating the polynomial keys are combined in a non-linear manner when they are added over the integers creating a non-linear structure for the local key material stored on a communication unit. The above choice for N and pⱼ has the property that: (i) the size of N is fixed for all communication units and linked to a; (ii) the non-linear effect appears on the most significant bits of the coefficients forming the key material stored on the device. Because of that specific form the shared key may be generated by reducing module 2^{b} after the reduction modulo N.

### Registration Steps

In the registration step each communication unit is assigned key material (KM). A communication unit is associated with an identity number. The identity number may be assigned on demand, e.g. by the TTP, or may already be stored in the device, e.g., stored in the device at manufacture, etc.

The TTP generates a set of key material for a device A as follows:

KM^{A}(X)=Σⱼ₌₁^{m}<fⱼ(x,A)>pⱼ2^{b}Σᵢ₌₀^{a}ε_{A,i}Xⁱ=ΣᵢCᵢ^{A}xⁱ

Wherein KM^{A}(X) is the key material of a device with identity number A; X is a formal variable. Note that the key material is non-linear. The notation < . . . >ₚⱼ denotes reducing modulo pⱼ each coefficient of the polynomial between the brackets. The notation ‘ε_{A,i}’ denotes a random integer, which is an example of an obfuscating number, such that |ε_{a,i}|<2^{(a+1-i)b}. note that any one of the random integers may be positive or negative. the random numbers ε are generated again for each device. The term Σ_{i≦0}^{a}ε_{A,i}Xⁱ thus represents a polynomial in X of degree a, of which the coefficient length is shorter with increasing Σᵢ₌₀^{a}|ε_{A,i}|·2^{b+i} is small, e.g., <2a. The key material is stored on device A in the form of the coefficients cᵢ^{A}.

Thus, in the example, the TTP provides local key material which does not correspond to fully symmetric functions. Rather, a random modification (obfuscation) has been introduced to the individual key generating function for the individual communication unit. This obfuscation of the underlying symmetric function results in keys generated at the individual communication units not being fully identical and thus substantially complicates collusion attacks.

The evaluation of the univariate polynomials Σⱼ₌₁^{m}<fⱼ(x,A)>ₚⱼ is each individually done modulo a smaller modulus pⱼ but the summation of these reduced univariate polynomials themselves is preferably done modulo N. Also adding the obfuscating polynomial 2^{b}Σᵢ₌₀^{a}ε_{A,i}Xⁱ may be done using natural integer arithmetic or, preferably, modulo N. The key material comprises the coefficients Cᵢ^{A} with i=0, . . . , a. The key material may be presented as a polynomial as above. In practice, the key material may be stored as a list, e.g., an array, of the integers Cᵢ^{A}. The device A also receives the numbers N and b. Manipulation of polynomials may be implemented, e.g., as manipulation of arrays containing the coefficients, e.g., listing all coefficient in a predetermined order. Note that polynomials may be implemented, in other data structures, e.g., as an associative array (aka a ‘map’) comprising a collection of (degree, coefficient) pairs, preferably such that each coefficient appears at most once in the collection. The coefficients Cᵢ^{A} that are provided to the device are preferably in the range 0, 1, . . . N−1.

In case, that the more general construction for N and the integer numbers pⱼ is used, the obfuscating polynomial needs to be adapted so that the random numbers ε affect different parts of the coefficients. For instance, if the non-linear effect is introduced in the least significant bits of the coefficients of the key material stored on the communication units, then the random numbers should only affect the highest part of the coefficients and a variable number of bits in the lowest part of the coefficients. This is a direct extension of the method described above and other extensions are feasible.

### Use Phase

Once two devices A and B (e.g. corresponding to the first communication unit 101 and the second communication unit 103 of FIGS. 1-5) have an identity number and received their key material from the TTP, they may use their key material to obtain a shared key. Device A may perform the following steps to obtain his shared key. First, device A obtains the identity number B of device B, then A generates the first cryptographic key by computing the following:

K_{AB}=<<KM^{A}(x)|_{x=B}>_{N}>₂_{^{b}}=<<ΣᵢCᵢ^{A}Bⁱ>_{N}>₂_{^{b}}

That is, A evaluates his key material, seen as an integer polynomial, for the value B; the result of evaluating the key material is an integer. Next device A reduces the result of the evaluation first modulo the public modulus N and then modulo the key modulus 2^{b}. The result will be referred to as A's first cryptographic key, it is an integer in the range of 0 up to 2^{b}−1.

Device A then generates a perturbation value, e.g. as a random value with a maximum magnitude of PₘₐₓIt then generates the corresponding shared key by a modulus N addition of the first cryptographic key K_{AB} and the perturbation value ε. Thus, it generates

\tilde{K}_{AB}=<K_{AB}+ε>_{N}

For its part, device B can generate B's first cryptographic key by evaluating its key material for identity A and reducing the result modulo N and then modulo 2^{b}, i.e it can calculate the value:

K_{BA}=<<KM^{B}(x)|_{x=A}>_{N}>₂_{^{b}}=<<ΣᵢCᵢ^{B}Aᵢ>_{N}>₂_{^{b}}

Because the bivariate polynomials are not symmetric A's first cryptographic key and B's first cryptographic key are generally not equal. The particular requirements on the integers p₁, p₂, . . . , Pₘ, and on the random numbers E are such that the keys however may be equal and indeed are almost always close to each other modulo two to the power the key length.

As mentioned, in addition A will proceed to modify the first cryptographic key by adding a perturbation value to it. This perturbation value may as previously discussed be random value and will typically be kept very small. Furthermore, the addition of the perturbation value is performed modulo N. The resulting key is thus the shared cryptographic key that will be used by the communication units.

Although B will typically not have generated a first cryptographic key which is identical to the shared cryptographic key generated by B, it is almost certain that these keys are close to each other. B may accordingly determine possible values of the shared cryptographic key and perform key confirmation for each of these possible keys. For example, A may send to B a message containing the pair (m, E(m)), wherein m is a message, say a fixed string or a random number, and E(m) is an encryption using A's shared key.

By decrypting E(m) using B's different possible keys, B may verify if any of these the keys are equal to the shared key. If so, B may choose to respond to A informing him of the situation.

Key confirmation. It may be desirable for one of A and B to send a key confirmation message to the other party.

A so-called key confirmation message (KC) enables the recipient of the key confirmation message to verify that he has computed the same key as the sender of the key confirmation message. In particular in a key sharing scheme for which it is known that the key established by both parties may differ, a key confirmation message may be used both as a confirmation that both have established the same key, and if not, to determine an equal shared key. For example, in general a MAC (message authentication code) based on the established key can serve as the confirmation message, e.g. an HMAC based on SHA2 or SHA3, or a CMAC based on AES, and the like. Also a cryptographically strong hash function may be used, e.g., a hash of the established key may be used as the key confirmation message. The hash may be computed over the key itself. The MAC can be computed over data which is known by B or included in the key confirmation message, e.g. a nonce, etc.

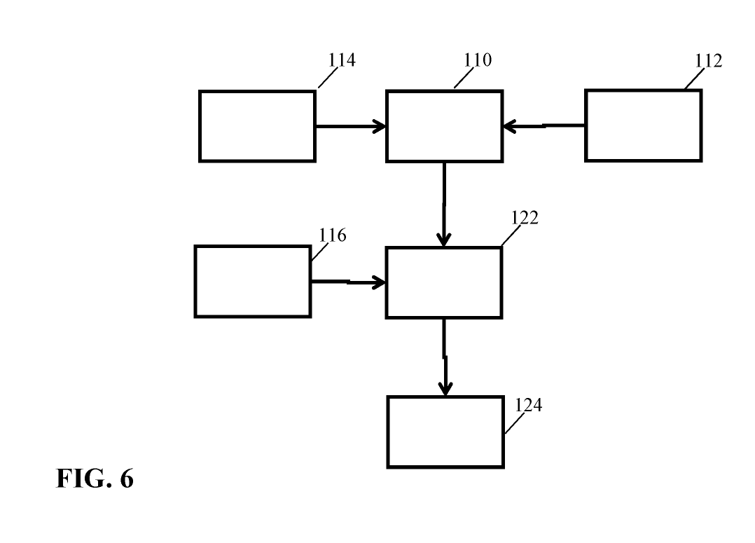

FIG. 6 is a schematic block diagram illustrating a root key material generator which may be part of the TTP. A key material obtainer is configured to provide input data, except an identity number, needed by a local key material generator for generating local key material. A key generator is an example of a key material obtainer. Instead of generating all or part of the input data, some parameters can also be obtained by the root key material generator by receiving them; for example the key obtainer may comprise an electronic receiver for receiving input data, e.g., a public and private modulus. A key material obtainer obtains all the needed parameters except the identity numbers from an external source. In an embodiment a, b, m are predetermined, e.g., received and the public modulus and the private moduli and corresponding symmetric bivariate polynomials are generated. In an embodiment also the public modulus is pre-determined, e.g., received.

The root key generator comprises a polynomial degree element 612, a key length element 614 and a number of polynomials element 616 configured to provide the polynomial degree, the key length and the number of polynomials, i.e., a, b and m respectively. Although these elements may be generated, e.g., depending on circumstances, typically these parameters are chosen by a system designer. For example, the elements may be designed as non-volatile memories, or as receivers for receiving the element values, or as volatile memories connected to a receiver, etc. A suitable choice includes a=2, b=128, m=2. Any one of the numbers may be increased or decreased to obtain a more or less secure system.

The root key generator comprises a public modulus element 610 configured to provide the public modulus N. The public modulus may or may not be chosen by a system designer. For example, the public modulus may be set to a convenient number allowing fast modular reduction (close or equal to a power two). The public modulus is chosen within a range determined by the elements 612 and 614.

The root key generator comprises a private modulus manager 622 configured to provide the private modulus p, or multiple private moduli p₁, . . . , pₘ. For example, they are chosen at random within the appropriate bounds.

The root key generator comprises a symmetric bivariate polynomial manager 624 configured to provide the symmetric bivariate polynomial f, or multiple symmetric bivariate polynomials f₁, . . . , fₘ. Each symmetric bivariate polynomial is chosen with coefficients random modulo the corresponding private modulus, i.e. the private modulus having the same index. The coefficients may be chosen within the range 0 to p−1, and may be chosen at random.

The private moduli may be chosen by adding or subtracting a multiple of two to the power of the key length to the public modulus. This will result in private moduli such that the difference with the public modulus ends in a series of consecutive zeros. One may also choose a public modulus and one or more private moduli such that a series of key length consecutive zeros occurs not at the end but another position, say position ‘s’, counting from the least significant bit.

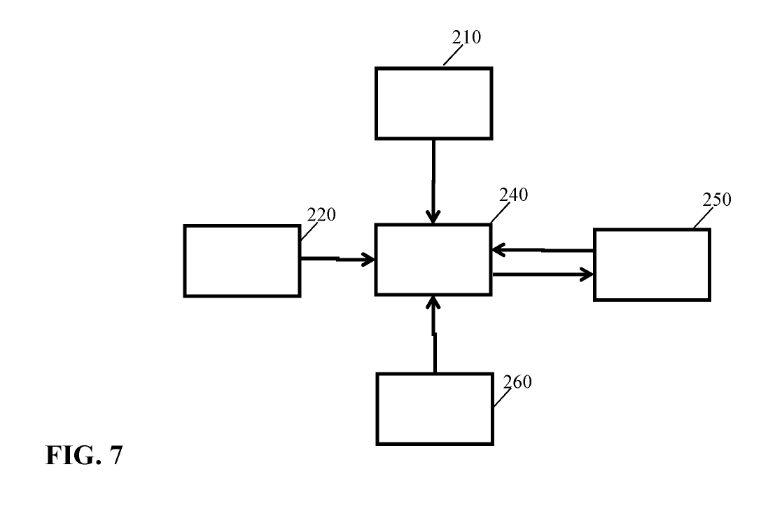

FIG. 7 is a schematic block diagram illustrating a local key material generator which may be included in the TTP. The key material generator and the local key material generator together form a system for configuring a communication unit for key sharing.

The local key material generator comprises a polynomial manipulation device 740. The local key material generator comprises a public material element 710 for providing the public parameters a, N to the polynomial manipulation device 740. The local key material generator comprises a private material element 720 for providing the private parameters pᵢ, fᵢ and m to the polynomial manipulation device 740. Elements 710 and 720 may be implemented by the corresponding elements of the key material generator; these elements may also be memories or busses to connect to the key material generator.

In the example, the local key material generator comprises an obfuscating number generator 760 which provides an obfuscating number ‘ε_{A,i}’ to the polynomial manipulation device 740. The obfuscated number may be a random number, e.g. generated with a random number generator. The obfuscating number generator 760 may generate multiple obfuscating numbers for multiple coefficients of the univariate polynomial. In an embodiment an obfuscating number is determined for each coefficient of the univariate polynomial.

The local key material generator comprises a communication unit manager 750 configured to receive an identity number for which the local key material must be generated, e.g., from a communication unit (e.g. the first communication unit 101 or the second communication unit 103), and is configured to send the local key material to the communication unit corresponding to the identity number. Instead of receiving an identity number, it may also be generated, e.g., as a random, serial or nonce number. In the latter case the identity number is sent along with the local key material to the communication unit. The polynomial manipulation device 740 obtains, possibly multiple, univariate polynomials by substituting the identity number from manager 750 into each one of the bivariate polynomials and reducing each modulo the corresponding private modulus. The resulting multiple reduced univariate polynomials are added, coefficient wise, with natural arithmetic addition. Also added are the one or more obfuscating numbers. Preferably, the result is reduced, again coefficient wise, modulo the public modulus; the coefficients of the latter may be advantageously represented in the range 0 to N−1.

The obfuscated univariate polynomial is part of the local key material corresponding to the identity number. If needed, the public modulus, degree and the key length are also sent to the communication unit. Thus, the local key material defines a key generating polynomial which can generate the first cryptographic key which may then be modified by the perturbation value locally determined in the individual communication unit.

It will be appreciated that although the above description focuses on an application wherein the key generating functions defined by the local key material are polynomials, they may in other embodiments be other functions.

It will be appreciated that the invention also extends to computer programs, particularly computer programs on or in a carrier, adapted for putting the invention into practice. The program may be in the form of source code, object code, a code intermediate source and object code such as partially compiled form, or in any other form suitable for use in the implementation of the method according to the invention. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the means of at least one of the systems and/or products set forth.

It will be appreciated that the above description for clarity has described embodiments of the invention with reference to different functional circuits, units and processors. However, it will be apparent that any suitable distribution of functionality between different functional circuits, units or processors may be used without detracting from the invention. For example, functionality illustrated to be performed by separate processors or controllers may be performed by the same processor or controllers. Hence, references to specific functional units or circuits are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units, circuits and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements, circuits or method steps may be implemented by e.g. a single circuit, unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc do not preclude a plurality. Reference signs in the claims are provided merely as a clarifying example shall not be construed as limiting the scope of the claims in any way.

1. A method of operation for a first communication unit, the method comprising,
obtaining local key material for the first communication unit, the local key material originating from a Trusted Third Party and defining a first key generating function for generating a cryptographic key as a function of at least one identity of a communication unit different from the first communication unit;
obtaining an identity for a second communication unit, the second communication unit being different from the first communication unit;
determining a first cryptographic key from the first key generating function based on the identity of said second communication unit;
locally generating a perturbation value for the first cryptographic key, the perturbation value not being uniquely determined by data originating from the Trusted Third Party; and
determining a second cryptographic key by applying the perturbation value to the first cryptographic key.

2. The method of claim 1 further comprising:
generating data using the second cryptographic key; and
transmitting the data to the second communication unit.

3. The method of claim 1 wherein locally generating comprises generating the perturbation value depending on the identity for the second communication unit.

4. The method of claim 3 wherein locally generating perturbation value comprises determining the perturbation value as a function of the second communication unit identity.

5. The method of claim 1 wherein the perturbation value is generated as a random value with a probability distribution.

6. The method of claim 5 wherein the probability distribution is confidential to the first communication unit.

7. The method of claim 1 wherein the perturbation value has a magnitude of no more than 10% of a magnitude of the first cryptographic key.

8. The method of claim 1 wherein the second cryptographic key is generated by a modular combination of the first cryptographic key and the perturbation value, the modular combination using a public modulus value.

9. A method of operation for a first communication unit, the method comprising:
obtaining local key material for the first communication unit, the local key material originating from a Trusted Third Party and defining a key generating function for generating a cryptographic key as a function of at least one identity of a communication unit different from the first communication unit;
obtaining an identity for a second communication unit, the second communication unit being different from the first communication unit;
determining a first cryptographic key from the key generating function based on the identity of the second communication unit;
receiving data from the second communication unit, the data being generated using a third cryptographic key, the third cryptographic key being a combination of a perturbation value and a cryptographic key dependent on an identity of the first communication unit;
determining a set of possible perturbation values for the second communication unit;
determining a set of possible cryptographic keys from the set of possible perturbation values and the first cryptographic key; and
selecting a shared cryptographic key for the second communication unit by performing a cryptographic operation in relation to the data using each of the cryptographic keys from the set of possible cryptographic keys, and selecting the shared cryptographic key as a cryptographic key of the set of possible cryptographic keys that meets a validity criterion for the cryptographic operation.

10. The method of claim 9 wherein determining the set of possible cryptographic keys comprises further determining the possible cryptographic keys in response to a possible non-symmetry between the first cryptographic key and the cryptographic key dependent on the identity of the first communication unit.

11. A method of operation for a communication system comprising a plurality of communication units; the method comprising a first communication unit performing the steps of:
obtaining local key material for the first communication unit, the local key material originating from a Trusted Third Party and defining a first key generating function for generating a cryptographic key as a function of at least one identity of a communication unit different from the first communication unit;
obtaining an identity for a second communication unit, the second communication unit being different from the first communication unit;
determining a first cryptographic key from the first key generating function based on the identity of said second communication unit;
locally generating a perturbation value for the first cryptographic key, the perturbation value not being uniquely determined by data originating from the Trusted Third Party; and
determining a second cryptographic key by applying the perturbation value to the first cryptographic key,
generating data using the second cryptographic key;
transmitting the data to the second communication unit; and
the second communication unit performing the steps of:
obtaining local key material for the second communication unit, the local key material originating from a Trusted Third Party and defining a second key generating function for generating a cryptographic key as a function of at least one identity of a communication unit different from the second communication unit,
obtaining an identity for the first communication unit,
determining a third cryptographic key from the second key generating function based on the identity of the first communication unit;
receiving the data from the first communication unit;
determining a set of possible perturbation values for the first communication unit;
determining a set of possible cryptographic keys by applying the set of possible perturbation values to the third cryptographic key; and
selecting a shared cryptographic key for the first communication unit by performing a cryptographic operation on the data using each of the cryptographic keys of the set of possible cryptographic keys, and selecting the shared cryptographic key as a cryptographic key of the set of possible cryptographic keys that meets a validity criterion for the cryptographic operation.

12. A communication unit comprising:
a processor for obtaining local key material for the communication unit, the local key material originating from a Trusted Third Party and defining a first key generating function for generating a cryptographic key as a function of at least one identity of a different communication unit;
a processor for obtaining an identity for a different communication unit;
a processor for determining a first cryptographic key from the first key generating function based on the identity of the different communication unit;
a generator for locally generating a perturbation value for the first cryptographic key,
the perturbation value not being uniquely determined by data originating from the Trusted Third Party; and
a processor for determining a second cryptographic key by applying perturbation value to the first cryptographic key.

13. A communication unit comprising:
a processor for obtaining local key material for the communication unit, the local key material originating from a Trusted Third Party and defining a key generating function for generating a cryptographic key as a function of at least one identity of a different communication unit;
a processor for obtaining an identity for a different communication unit;
a processor for determining a first cryptographic key from the key generating function based on the identity of the different communication unit;
a receiver for receiving data from the different communication unit, the data being generated using a third cryptographic key, the third cryptographic key being a combination of a perturbation value and a cryptographic key dependent on an identity of the communication unit;
a processor for determining a set of possible perturbation values for the different communication unit;
a processor for determining a set of possible cryptographic keys from the set of possible perturbation values and the first cryptographic key; and
a selector for selecting a shared cryptographic key for the different communication unit by performing a cryptographic operation in relation to the data using each of the cryptographic keys from the set of possible cryptographic keys, and selecting the shared cryptographic key as a cryptographic key of the set of possible cryptographic keys that meets a validity criterion for the cryptographic operation.

14. A communication system comprising:
a first communication unit comprising:
a processor for obtaining local key material for the first communication unit, the local key material originating from a Trusted Third Party and defining a first key generating function for generating a cryptographic key as a function of at least one identity of a communication unit different from the first communication unit,
a processor for obtaining an identity for a second communication unit, the second communication unit being different from the first communication unit,
a processor for determining a first cryptographic key from the first key generating function based on the identity of the second communication unit,
a generator for locally generating a perturbation value for the first cryptographic key, the perturbation value not being uniquely determined by data originating from the Trusted Third Party,
a processor for determining a second cryptographic key by applying the perturbation value to the first cryptographic key,
a data generator for generating data using the second cryptographic key;
a transmitter for transmitting the data to the second communication unit; and
the second communication unit comprising:
a processor for obtaining local key material for the second communication unit, the local key material originating from a Trusted Third Party and defining a second key generating function for generating a cryptographic key as a function of at least one identity of a communication unit different from the second communication unit
a processor for obtaining an identity for the first communication unit,
a processor for determining a third cryptographic key from the second key generating function based on the identity of the first communication unit;
a receiver for receiving the data from the first communication unit;
a processor for determining a set of possible perturbation values for the first communication unit;
a processor for determining a set of possible cryptographic keys by applying the set of possible perturbation values to the third cryptographic key; and
a processor for selecting a shared cryptographic key for the first communication unit by performing a cryptographic operation on the data using each of the cryptographic keys of the set of possible cryptographic keys, and selecting the shared cryptographic key as a cryptographic key of the set of possible cryptographic keys that meets a validity criterion for the cryptographic operation.

15. A computer program comprising computer program code means adapted to perform all the steps of claim 1 when the computer program is run on a computer.

16. A computer program as claimed in claim 15 embodied on a computer readable medium.
